(19) United States
(12) Patent Application Publication
(10) Pub. No.: US 2020/0086292 A1
(43) Pub. Date: Mar. 19, 2020

(54) LOW-TEMPERATURE REMOVAL OF H2S USING LARGE-SURFACE-AREA NANO-FERRITES OBTAINED USING A MODIFIED CHEMICAL COPRECIPITATION METHOD

(71) Applicant: INSTITUTO NACIONAL DE INVESTIGACIONES FORESTALES, AGRÍCOLAS Y PECUARIAS, Ciudad De México (MX)

(72) Inventor: Eutiquio BARRIENTOS JUÁREZ, Ciudad De México (MX)

(73) Assignee: INSTITUTO NACIONAL DE INVESTIGACIONES FORESTALES, AGRÍCOLAS Y PECUARIAS, Ciudad De México (MX)

(21) Appl. No.: 16/487,966

(22) PCT Filed: Feb. 19, 2018
(86) PCT No.: PCT/MX2018/000014

§ 371 Date: Nov. 26, 2019

(30) Foreign Application Priority Data
Feb. 22, 2017 (MX) MX/A/2017/002349

(51) Int. Cl. B01J 20/04; C01G 49/00; B01J 20/28; B01J 20/30; B01D 53/52; B01D 53/82

(52) U.S. Cl. CPC B01J 20/041; B01D 2253/306; B01J 20/28007; B01J 20/28011; B01J 20/28009; B01J 20/28016; B01J 20/28061; B01J 20/3085; B01D 53/52; B01D 53/82; C01P 2006/42; C01P 2004/64; C01P 2006/12; C01P 2006/10; C01P 2002/72; C01P 2004/04; B01D 2253/1124; B01D 2257/304; B01D 2253/304; C01G 49/0072

(57) ABSTRACT

The present invention relates to H₂S removal that may be contained in biogas or industrial process gases in concentrations of 35-15000 ppm. By means of nanoparticles of manganese ferrite MnxFe₃-xO₄ with x=0%, 0.1%, 0.3% and 0.5%, obtained by means of chemical co-precipitation from solutions of chlorides and at a temperature below 100° C. With surface area of 142-240 m²/g and particle size of 7-9 nm. And that is done through a set of components such as: pressure regulating valve, a flow meter, a piston flow rector, a pressure gauge, a three-way valve, a biogas measuring device, a gas scrubber and a burner biogas.

### FIELD OF THE INVENTION

The present invention relates to the disciplinary field of chemistry and physics materials. Because the objective of the present invention is to describe the removal of H₂S by using nanoparticles of nanometer-sized ferrites and synthesized by the modified chemical co-precipitation method. The removal is carried out of gas containing high concentrations of H₂S and is developed by continuous flow in a reactor and at room temperature.

### BACKGROUND

CH₄ has a greenhouse effect 21 times greater than CO₂ in the atmosphere, which makes it preferable to use its energy power and emit CO₂ into the environment from its combustion. An attached problem in the production and use of biogas is hydrogen sulfide (H₂S) present in the gas mixture. H₂S is produced naturally during the reduction of sulfate and sulfur-containing organic compounds, it is associated with the metabolism of anaerobic bacteria and archaea. H₂S is an unwanted compound in biogas as it generates corrosion and wear in combustion engines, which results in high maintenance costs. Various minerals have been tested for desulfurization of biogas in situ, adding them in anaerobic reactors, such as iron ores (magnetite, magemite, hematite), at a dose of 5 g in 250 ml of an experimental reactor.

The addition of these minerals in larger reactors could promote the production of higher quality biogas. The most used systems to treat the gas mixture, coming from the bioreactor, are adsorption systems based on beds of activated carbon and metal oxides; Adsorption in iron oxides is a viable alternative in the removal of H₂S in biogas, removal efficiencies of up to 99% have been reported, in addition to its low cost. In terms of removal, there is a direct relationship between the amount of H₂S removed and the surface area of the adsorbent material. However, conventional iron oxides have the limitation that their surface area hardly exceeds 82 m² g⁻¹.

There are patents that talk about the modification of the surface area by different methods, some of them are mentioned below:

EP87856A1 discusses the removal of H₂S normally present in gas by means of an absorbent solution containing amino groups and is selective for H₂S where the gas also contains CO₂. In the process of removal, it is carried out in a tower that is capable of removing CO₂ and H₂S in some conditions.

In patent EP0962147A1 he describes a method to generate a substance based on regenerated and submerged cellulose to generate a coagulate that can be regenerated when subjected to baths in stages or heating by means of tubes that carry bituminous carbon to react in an intermediate zone and that treats CO₂ and H₂S emissions.

US2005003515 talks about a system for removing H₂S from methane which includes at least one cartridge-type biofilter that works to sustain microbial activity by consuming H₂S contained in methane gas. The H₂S contained in methane is transported directly to the biofilter and which contains at least one cartridge containing microorganisms and whose function is to biodegrade the H₂S. Then the treated methane is recirculated and stored in a reservoir for later use.

Patent U.S. Pat. No. 4,532,117 talks about a method to remove H₂S using a regenerable accusation system capable of absorbing H₂S and converting to elemental sulfur, this is provided to recondition contaminated systems with the feeding of bacteria and keeps the system sustainably free of bacteria. The aqueous solution is regenerated with aliphatic acid.

Patent CN103706230A talks about a method for removing H₂S from geothermal steam under vacuum. A thin curtain of water-acrolein drops is atomized while the geothermal vapor is condensed in an approximate amount of 2:1 in molar ratio of acrolein and H₂S.

The removal range is approximately 0.1 ppm to 500 ppm H₂S. The acrolein allows to react with the H₂S gas in a non-volatile way and is directed to a tower to be cooled and the compound separated.

The 20090188164 patent relates to a method for removing H₂S from an acid gas mixture, and reacts with a metal oxide where the gas reacts with the valence state of the metal in a reactor containing an aqueous solution. A REDOX electrochemical reaction is carried out including the compound in a reduced state for subsequent regeneration between an anode and a cathode.

Patent AU1994059391 talks about the removal of H₂S and S in liquid oil by adding soluble oil of a composition with alkyl groups containing 7 to 22 carbon in its structure.

U.S. Pat. No. 5,700,438 describes a process for removing H₂S and mercaptans from steam, the process is carried out by contacting an aqueous solution containing copper and a group of water-insoluble amines with copper sulfate and which can be regenerated. Copper sulfate is removed from the system and recovered. Finally, another water-soluble copper compound is generated.

U.S. Pat. No. 4,537,753 describes the removal of CO₂ and H₂S from natural gases by means of an absorption process with a temperature range of 40-100° C. and containing 20 to 70% by weight of methyl groups. H₂S is removed from the bottom of the column and then regenerated to be used in another absorption stage.

U.S. Pat. No. 3,205,164 relates the process of removing H₂S from hydrocarbons by the reaction t absorption in an alkyl amine and which is capable of being recycled.

U.S. Pat. No. 3,435,590 shows a process for removing H₂S and CO₂ as a mixture at low temperature. Liquid polypropylene carbonate, acetone or alcohol is used. Some of these reagents or in mixture are applied to absorb H₂S and CO₂ and then release hot H₂. The residual gases are removed by a bath where a boiling process is generated.

U.S. Pat. No. 5,096,589 describes a method for treating water containing H₂S, the system includes demineralized water to remove mineral impurities. The demineralized water is then treated with chlorine to convert the H₂S into hydrochloric acid and sulfuric acid water while the pH is changed. The water is then neutralized with sodium hydroxide.

U.S. Pat. No. 5,738,834 details the removal of H₂S from gas vapor contained in natural gas. It contacts a non-aqueous substance which reacts the H₂S to generate elemental sulfur, then an organic base is used to promote the reactions. H₂S is sipped in the liquid and then reacts with a sulfate to form other molecules. Cooling is performed to obtain sulfide crystals that are easily separated.

U.S. Pat. No. 5,976,373 relates how the treatment of anaerobic systems and other contaminants is carried out. The chemical equation reaches the reaction of H₂S with oxygen until elemental sulfur is formed. A filter is used to remove solids and drag liquid and solids towards an oxygen-rich flow, the flow is directed to a bed of activated carbon where a reaction occurs.

U.S. Pat. No. 6,881,389 B2 explains the process for removing H₂S and CO₂ from natural gas through contact with seawater. A set of stages where a gas washing is performed is described, each stage has a loss of pressure.

U.S. Pat. No. 8,404,031 B1 describes the removal of H₂S and describes the manufacturing process of the system. The material captures the iron to be solubilized with hydrochloric acid. The resulting solution is treated with a caustic soda solution to increase the pH and then neutralized.

### BRIEF DESCRIPTION OF THE INVENTION

The characteristic details of the removal process from nanometric ferrites are presented in the description of the figures; the nanoparticles used are MnxFe₃-xO₄ Manganese Ferrite with x=0%, 0.1%, 0.3% and 0.5%.; the average size of the nanoparticles is 10 nm; the surface area of the nanoparticles used is 142 to 240 m²/gr; the density of the material is 6,700 to 9,700 kg/m³.

### BRIEF DESCRIPTION OF THE FIGURES

FIG. 1 presents 5 steps necessary for the manufacture of the material by means of modified chemical co-precipitation.

FIG. 2 shows a 9-step process for the removal of H₂S by a reactor containing magnetic nanoparticles obtained by the modified chemical co-precipitation method.

FIG. 3 shows a diffractogram of the magnetic material obtained after the manufacturing process. Said material before the removal process has a single magnetic phase corresponding to the reverse spinel ferrite. The average crystallite size presented in the diffractogram is 8.2 nm. It is observed that after the removal process there is a new phase of iron mono-sulphide (FeS).

FIG. 4 presents images made by transmission electron microscopy. The material has an average size of 8.9 nm.

### BRIEF DESCRIPTION OF THE FIGURES:

In order to fully appreciate the entire process, I will allow myself to present a brief description. Based on the figures presented, the invention refers to the H₂S removal process by using nanometric ferrites obtained at temperatures below 100° C. The process of obtaining the nanoparticles is through the modified process of chemical co-precipitation where the speed of agitation in the mixture of the chlorides used for the precipitation of ferrites is varied. The speed variation is in a range of 20,000 to 48,000 RPM. After obtaining the material, it should be washed until a pH in the range of 7-8 is reached, and then dried for 3 days at a temperature of 70° C.

### DETAILED DESCRIPTION OF THE INVENTION

The synthesis of the ferrite nanoparticles with high surface area is carried out by a chemical method, with the help of a high RPM device and with a constant heating system.

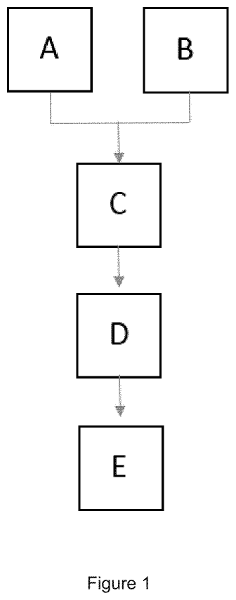

Said method of FIG. 1 consists of the following steps:
A. AGITATION. A stirring and dilution process of ferrous chloride is carried out at a concentration of 0.177 M. The solution must be stirred at a speed of 200-2200 RPM and at a constant temperature of 25° C.
B. PREPARATION OF THE MIX. A stirring and dilution process of ferric chloride is carried out at a concentration of 0.483 M. The solution must be stirred at a speed of 200-2200 RPM and at a constant temperature of 25° C. The ratio of Fe +2/Mn+2 is between 0.177 M and 0.50 M, present in chemical reagents based on chlorides.
C. WARM UP. The mixture of three solutions is carried out: ferric chloride, manganese chloride and ferrous chloride, the temperature must be elevated from 25° C. to 70° C. And with constant agitation of 20,000 RPM to 30,000 RPM.
D. PRECIPITATION. 10% ammonium hydroxide is added once the temperature of 70° C. is reached and stirring is raised to 45,000-48,000 RPM, a precipitate of ferrite nanoparticles is generated.
E. WASHING. The solution is cooled to 25° C. containing the nanoparticles of manganese ferrite and washing is done by accelerated precipitation with magnets and decanting process until a pH of 7-8 is reached.

In order to specify some results, he following results are presented, but not limited to, the following results,

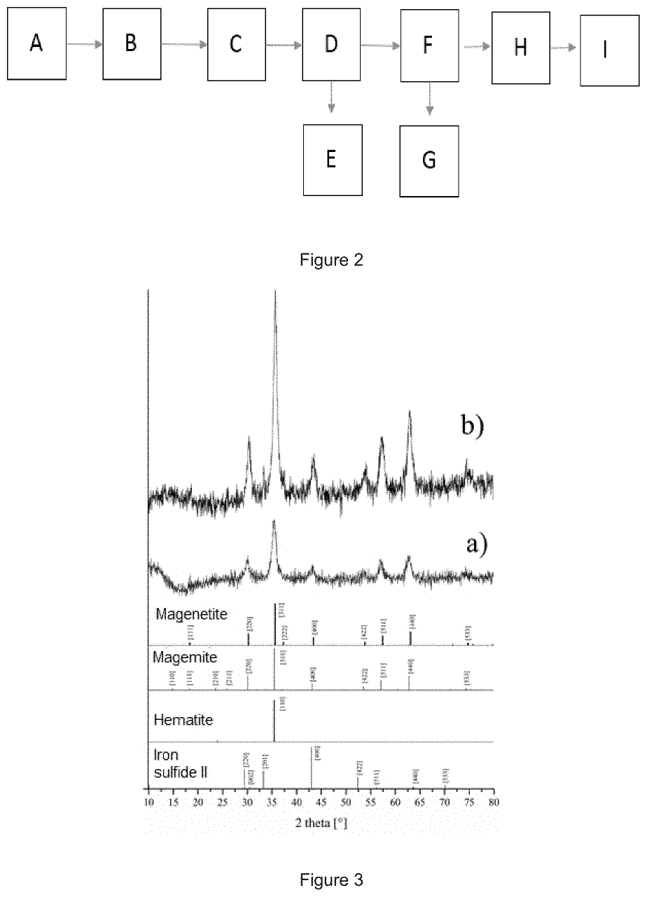

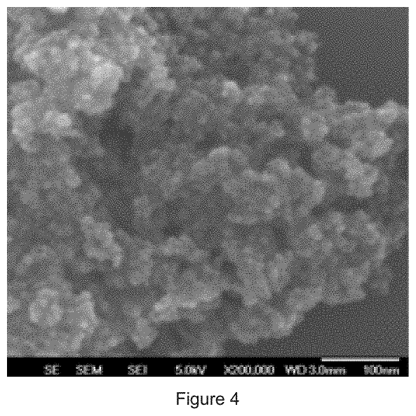

The graph of FIG. 2, The process of H₂S removal by ferrite nanoparticles in a reactor is shown,
A. BIOGAS. The H₂S contained in synthetic biogas with concentrations above 5000 ppm is directed through a port of entry into the system where the removal will take place. Biogas is composed of 55% CH₄ and 40% CO₂ and 5% Balance gas.
B. FLOW CONTROL. The flow control is carried out by means of an adjustable opening valve and with a range of 0.5 to 500 LPM to be able to control the amount of gas that passes through the removal filter.
C. FLOW MEASUREMENT. The flow must be measured after being controlled in order to estimate the amount of H₂S that the filter is able to remove for a period of time during the biogas generation process.
D. REACTOR. The H₂S removal process is carried out in a reactor known as a piston flow and with a volume of 0.5 to 30 L. The material is placed in the form of tablets with a diameter of 0.0254-0.1 m and a thickness of 0.01-0.05 m. The pads are subjected before placing them in the reactor at a compression of 0.25-25 psi and a heat treatment of 70° C. for 4 hours. When the pads are placed inside the reactor, the gas is passed from the bottom of the reactor so that a phenomenon of diffusion of the material occurs until it reaches its maximum saturation when in contact with the Biogas containing H₂S.
E. MANOMETER. The pressure gauge inside the system is to regulate the biogas pressure that enters the reactor where the ferrite nanoparticle tablets are located. System pressure should be maintained between 2-35 psi.
F. THREE-WAY VALVE. The three-way valve is used in one position to be able to perform the H₂S removal percentage measurement after passing through the filter of ferrite nanoparticles obtained by modified chemical co-precipitation.
G. BIOGAS MEASUREMENT. The percentage of H₂S removed by the reactor-shaped filter is measured using a biogas probe.
H. GAS WASHER. In the other position of the three-way valve, the biogas is passed to a gas scrubber in order to remove the CO₂ contained in the biogas.
I. BURNER. The gas burner is a system in which biogas combustion is generated and process heat is generated but with a biogas without H₂S concentration.
J. The graph of FIG. 3 shows a diffractogram showing the phases present in the ferrites before being subjected to the H₂S removal process. In the lower part there is the material after removing H₂S and it is observed that there is the presence of iron mono-sulfide (FeS), which confirms that there is removal by means of the nanoparticles obtained through the modified chemical co-precipitation.
K. The graph of FIG. 4 shows an image with ferrite nanoparticles with an average size of 8.9 nm and a surface area of 142 m²/g.

1. The use of magnetic nanoparticles of manganese ferrite MnxFe₃-xO₄ with x=0%, 0.1%, 0.3% and 0.5%, this material has the following characteristics: average nanoparticle size is 10 nm, the surface area of the nanoparticles used is 142 to 240 m²/gr, the density of the material is from 6,700 to 9,700 kg/m.

2. The manufacturing process of the nanoparticles described in claim 1, wherein the manufacturing method by means of modified chemical co-precipitation and with the following characteristics: stirring and dilution process of ferric chloride at a concentration of 0.483 M, the solution should be stirred at a speed of 200-2200 RPM and at a constant temperature of 25° C., he ratio of Fe+2/Mn+2 is between 0.177 M and 0.50 M, present in chemical reagents based on chlorides; the mixture of three solutions is carried out: ferric chloride, manganese chloride and ferrous chloride, the temperature must be elevated from 25° C. to 70° C., and with constant agitation of 20,000 RPM to 30,000 RPM, 10% ammonium hydroxide is added once the temperature of 70° C. is reached and stirring is raised to 45,000-48,000 RPM, a precipitate of ferrite nanoparticles is generated, then the solution is cooled to 25° C. containing the nanoparticles of manganese ferrite and washing is done by accelerated precipitation with magnets and decanting process until a pH of 7-8 is reached.

3. A process for the removal of H₂S that may be contained in biogas or industrial process gases, by using ferrite nanoparticles with characteristics of claim 1, as follows:
A. PREPARATION, the material preparation process is carried out by means of modified chemical co-precipitation, the use of solutions with ferrous and ferrous chlorides, the stirring speed of 20,000 to 48,000 RPM and at a temperature below 100° C.;
B. USE OF FERRITES OBTAINED BY MODIFIED CHEMICAL CO-PRECIPITATION, the use of ferrite nanoparticles obtained by modified chemical co-precipitation, the material is placed in the form of tablets with a diameter of 0.0254-0.1 m and with a thickness of 0.01-0.05 m, the tablets are subjected to a compression of 0.25-2.5 psi.
C. H₂S REMOVAL SYSTEM, the system consists of a pressure regulating valve, a flow meter, a piston flow rector, a pressure gauge, a three-way valve, a biogas measuring device, a gas scrubber and a biogas burner.
